(19) United States
(12) Patent Application Publication
(10) Pub. No.: US 2016/0126670 A1
(43) Pub. Date: May 5, 2016

(54) OPTICAL TRANSCEIVER MODULE AND ASSEMBLY HAVING A LATCHING/DELATCHING MECHANISM THAT WORKS WITH SYMMETRIC AND ASYMMETRIC CAGE LATCHES

(71) Applicant: Avago Technologies General IP (Singapore) Pte. Ltd., Singapore (SG)

(72) Inventor: Seng-Kum Chan, Santa Clara, CA (US)

(21) Appl. No.: 14/529,626

(22) Filed: Oct. 31, 2014

(51) Int. Cl. H01R 13/627

(52) U.S. Cl. CPC H01R 13/6275

(57) ABSTRACT

An optical transceiver module and assembly are provided with a latching/delatching mechanism that is well suited for use with cages or receptacles that have symmetrically-located or asymmetrically-located latches. The latching/delatching mechanism comprises stops that engage the cage latches in the stored, or non-actuated, state and comprises delatching features that engage the cage latches in the pulled, or actuated, state. The configurations of the stops and of the delatching features ensure that the engagement of the stops with the cage latches in the stored, or non-actuated, state is sufficient to provide latching and that the engagement of the delatching features with the cage latches in the pulled, or actuated, state is sufficient to provide delatching, regardless of whether the cage latches are asymmetrically located or symmetrically located on the cage or receptacle.

### TECHNICAL FIELD OF THE INVENTION

The invention relates to optical transceiver modules. More particularly, the invention relates to an optical transceiver module having a latching/delatching mechanism that is well suited for use with symmetric and asymmetric cage latches.

### BACKGROUND OF THE INVENTION

State-of-the-art digital communication switches, servers, and routers currently use multiple rows of duplex LC connector optical transceivers to meet information bandwidth and physical density needs. To be a commercially fungible product, the optical transceivers must have basic dimensions and mechanical functionality that conform to an industry standard Multi-Source Agreement (MSA). Of course, many optical transceiver designs that comply with and add value beyond the basic mechanical functionally set forth in the MSA are possible.

One known optical transceiver design that complies with such an MSA is the Quad Small Form-Factor Pluggable (QSFP) optical transceiver module. QSFP optical transceiver modules are designed to mate with an opening formed in a cage. The module housing has one or more receptacles configured to mate with one or more respective optical connector modules, such as one or more LC optical connector module. An optical fiber cable mates with each receptacle. Each optical fiber cable typically includes a plurality of transmit and/or receive optical fibers. A plastic pull tab is connected on its proximal end to a delatch device that is mechanically coupled to the module housing.

When the transceiver module housing is in the stored position in the cage, catches formed in opposite sides of the module housing engage respective latches formed in opposite sides of the cage to prevent the module housing from inadvertently coming out of the cage opening. When a user pulls on the distal end of the pull tab in the direction away from the cage opening, slider portions of the delatch device that run along opposite sides of the module housing slide to a limited extent along the respective sides of the module housing in the direction in which the pull tab is pulled. This movement of the slider portions causes outwardly-curved ramps formed on the ends of the slider portions to press outwardly against the respective latches of the cage to delatch, or disengage, them from the respective catches of the module housing. This allows the module housing to then be retracted from the cage opening.

In some QSFP mounting configurations, the cages have multiple openings arranged side-by-side for mating with the optical transceiver modules that are arranged side-by-side. The side-by-side optical transceiver modules that mate with the side-by-side cage openings share a common side wall of the cage. In such side-by-side configurations, the latches on the left and right sides of the cage are asymmetrically located relative to the bottom of the cage to allow the modules to share the common side walls of the cage. In such mounting configurations, the left-side latch of the cage is typically lower than the right-side latch of the cage. In other words, the distance between the left-side latch of the cage opening and the bottom of the cage is smaller than the distance between the right-side latch of the cage opening and the bottom of the cage. The asymmetric configuration of the cage latches allows transceiver module mounting density to be maximized and reduces cage costs.

One of the problems with the side-by-side QSFP mounting configuration is that the asymmetric configuration of the cage latches sometimes prevents the cage latches from catching the respective catches of the module housings. The catches of the module housings are symmetrically located, which can result in a catch failing to engage the respective latch due to the spatial offset between them. This, in turn, can result in the module housings inadvertently sliding out of the respective cage openings. In addition, the asymmetric configuration of the cage latches sometimes prevents the outwardly-curved ramps formed on the ends of the slider portions from fully engaging the respective latches of the cage when the user pulls on the pull tab. The outwardly-curved ramps are symmetrically located, and therefore may not fully engage the respective asymmetrically-located cage latches. This can make it difficult or impossible to remove a module housing from its respective cage opening. Another potential problem with the asymmetric configuration of the cage latches is that engagement between the symmetric outwardly-curved ramps and the asymmetric cage latches can twist and thereby damage the cage latches, which are typically made of sheet metal and easily bent.

Accordingly, a need exists for side-by-side mounting configuration that overcomes these problems. More particularly, a need exists for an optical transceiver module having a latching/delatching mechanism that is well suited for use in such side-by-side mounting configurations having symmetric or asymmetric latches.

### SUMMARY OF THE INVENTION

The invention is directed to an optical transceiver module and assembly having a latching/delatching mechanism that is well suited for use cages or receptacles having asymmetrically-located or symmetrically-located latches. In accordance with an embodiment of the optical transceiver module, the module comprises a module housing and a delatching device mechanically coupled to the module housing. The module housing has a top, a bottom, a first side, a second side, a first end and a second end. The first and second sides have first and second sets of stops formed therein, respectively. Each of the first and second sets of stops has N stops, where N is a positive integer that is equal to or greater than 2. The delatching device comprises an actuator mechanism and first and second slider portions having proximal ends that are mechanically coupled to the actuator mechanism and distal ends that are opposite the respective proximal ends. The first and second slider portions are positioned along the first and second sides of the module housing, respectively. The distal ends of the first and second slider portions have first and second sets of delatching features disposed thereon, respectively. The first and second sets of delatching features each have at least N+1 delatching features. When the delatching device is in a non-actuated state, the stops of the first and second sets of stops are interleaved with the delatching features of the first and second sets of delatching features, respectively.

In accordance with an embodiment of the optical transceiver module assembly, the assembly comprises a cage, a module installed inside of an opening of the cage, and a delatching device mechanically coupled to the module housing. The cage has a first end, a second end, a top, a bottom, a first side, and a second side. The first and second sides of the cage have first and second latches thereon, respectively, that extend a distance into the cage opening. The module housing has a top, a bottom, a first side, a second side, a first end and a second end. The first and second sides of the module housing have first and second sets of stops formed therein, respectively, each of which has N stops, where N is a positive integer that is equal to or greater than 2. The delatching device comprises an actuator mechanism and first and second slider portions. The first and second slider portions have proximal ends that are mechanically coupled to the actuator mechanism and distal ends that are opposite the respective proximal ends. The first and second slider portions are positioned along the first and second sides of the module housing, respectively. The distal ends of the first and second slider portions have first and second sets of N+1 delatching features disposed thereon.

In accordance with another embodiment of the optical transceiver module, the module includes a module housing, a slider and a delatching handle. The slider has first and second side slide members that are in parallel planes and a transverse member interconnecting proximal ends of the first and second side slide members. The transverse member is mechanically coupled to a distal end of the delatching handle. The first and second side slide members have distal ends that each have N+1 ramped features thereon, where N is a positive integer that is equal to or greater than 2. Adjacent ramped features are separated from one another by respective spaces. The module housing is mechanically coupled to the slider. The module housing has first and second catch features disposed on first and second sides of thereof, respectively, for engaging first and second latch features, respectively, disposed on opposite sides of a receptacle when the module is fully inserted into the receptacle and the delatching handle is in an unpulled, or non-actuated, state.

These and other features and advantages of the invention will become apparent from the following description, drawings and claims.

### BRIEF DESCRIPTION OF THE DRAWINGS

FIG. 1 illustrates a front perspective view of an optical transceiver module equipped with an illustrative embodiment of the latching/delatching mechanism.

FIG. 2 illustrates an enlarged view of the portion of the latching/delatching mechanism shown in the dashed box labeled 11 in FIG. 1.

FIG. 3 illustrates a front perspective view of a delatching device of the latching/delatching mechanism shown in FIG. 1.

FIG. 4 illustrates an enlarged view of the portion of the delatching device shown in the dashed box labeled 21 in FIG. 3.

FIGS. 5A and 5B illustrate side perspective views of the optical transceiver module shown in FIG. 1 with the delatching device of the latching/delatching mechanism shown in FIG. 1 in the stored state and in the pulled state, respectively.

FIG. 6 illustrates a side perspective view of two of the optical transceiver modules shown in FIG. 1 in the stored states inside of respective cage openings of a cage.

FIGS. 7A and 7B illustrate enlarged views of portions of the right and left sides of the cage shown in FIG. 6.

### DETAILED DESCRIPTION OF AN ILLUSTRATIVE EMBODIMENT

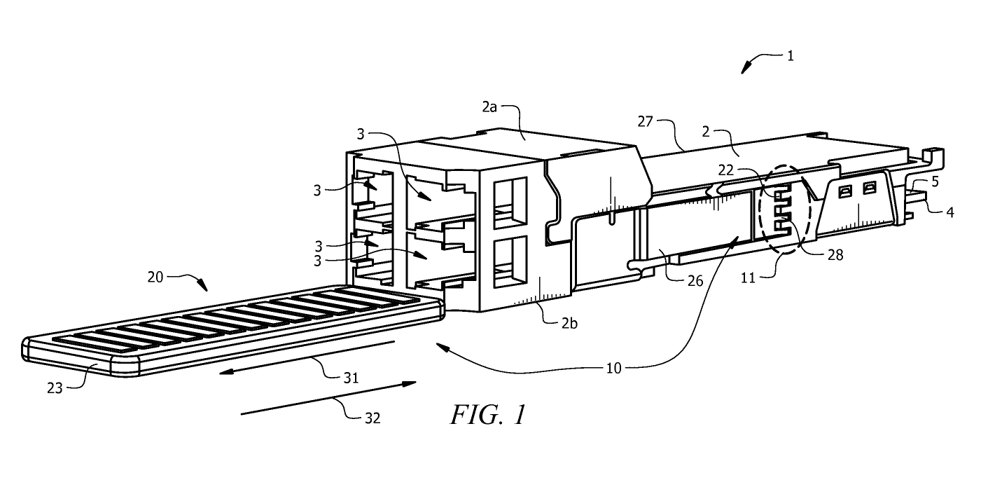

In accordance with illustrative embodiments of the invention, an optical transceiver module is provided with a latching/delatching mechanism that is well suited for use with cages or receptacles that have symmetrically-located or asymmetrically-located latches. The latching/delatching mechanism comprises stops that engage the latches in the stored, or non-actuated, state and comprises delatching features that engage the latches in the pulled, or actuated, state. The configurations of the stops and of the delatching features ensure that the engagement of the stops with the latches in the stored, or non-actuated, state is sufficient to provide latching and that the engagement of the delatching features with the cage latches in the pulled, or actuated, state is sufficient to provide delatching, regardless of whether the cage latches are asymmetrically located or symmetrically located on the cage. Illustrative, or exemplary, embodiments will now be described with reference to FIGS. 1-7, in which like reference numerals represent like components, features or elements.

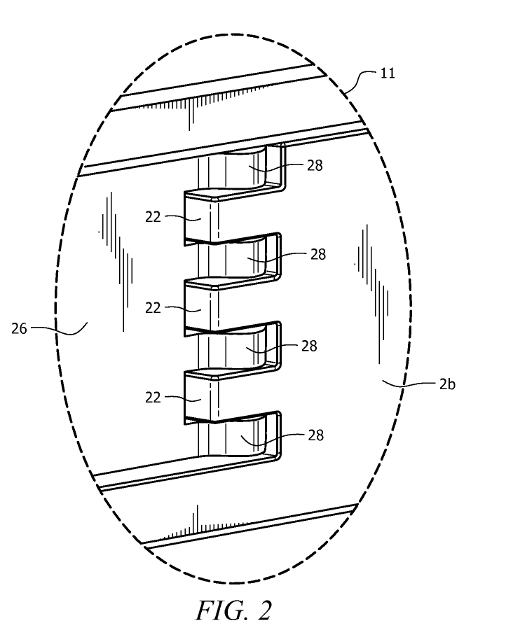

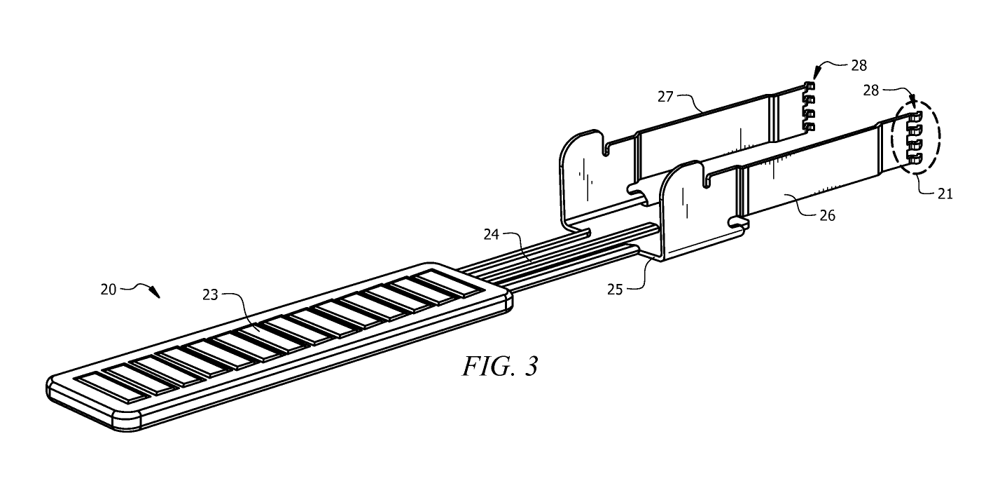

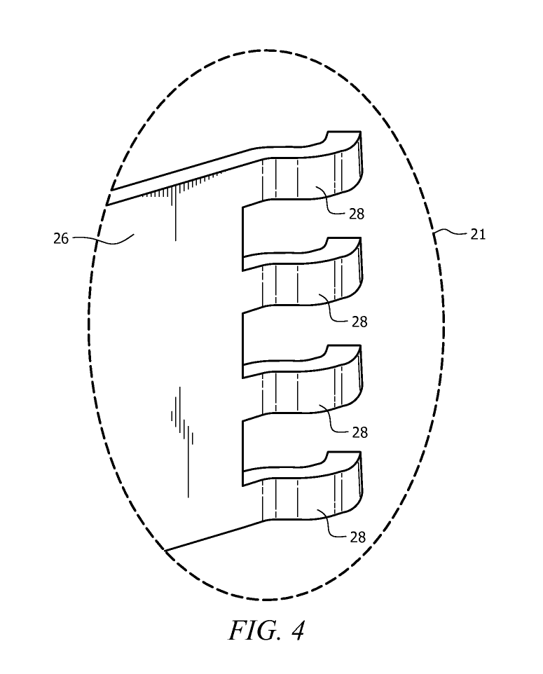

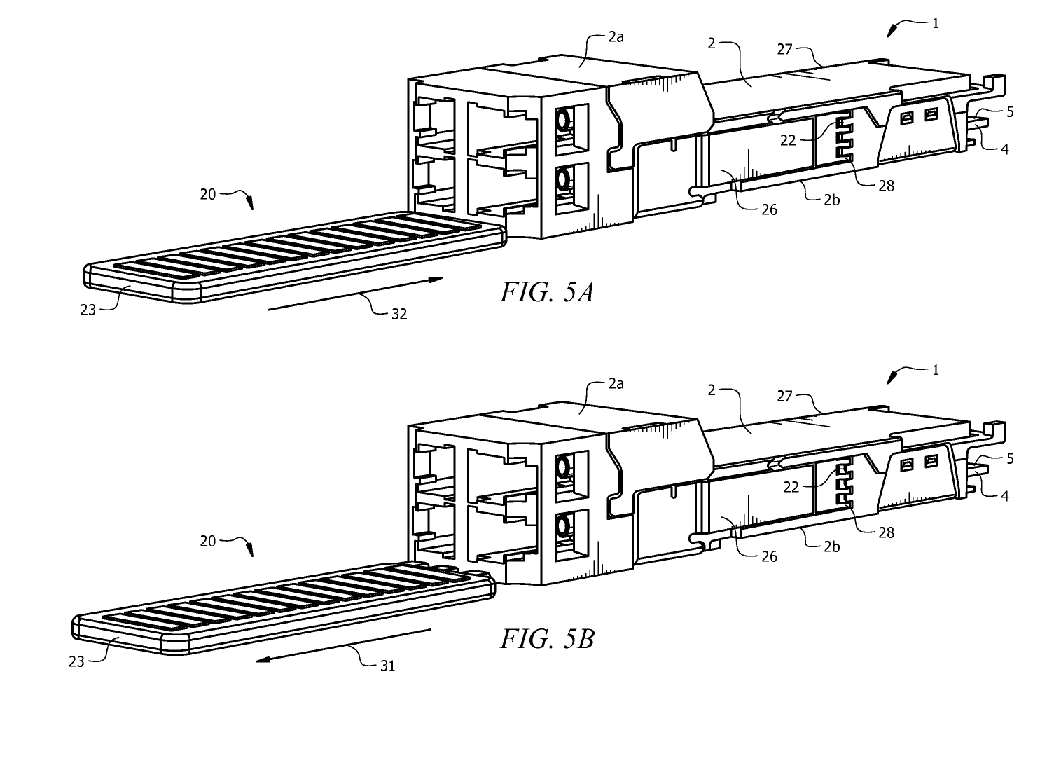

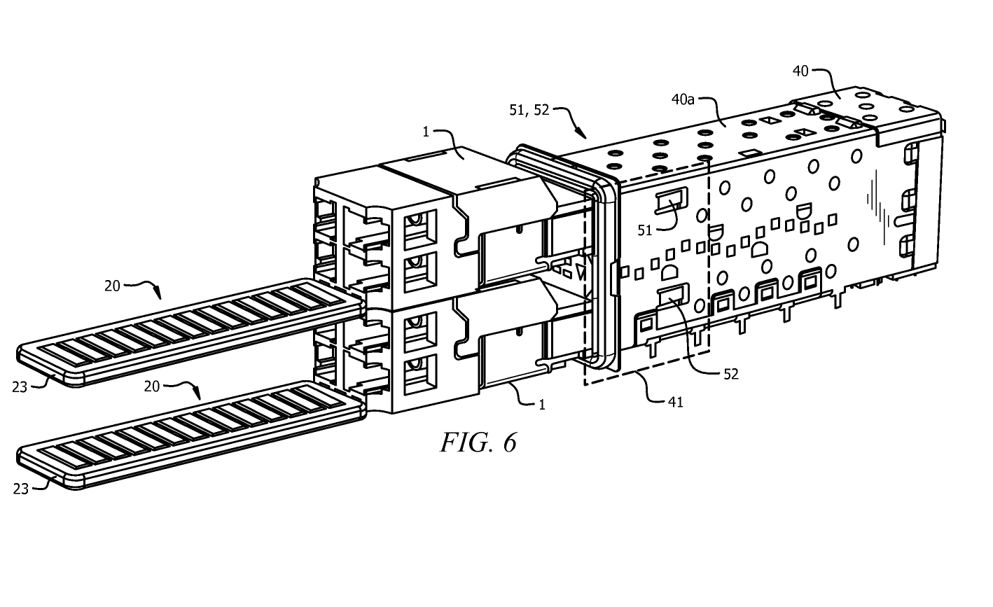

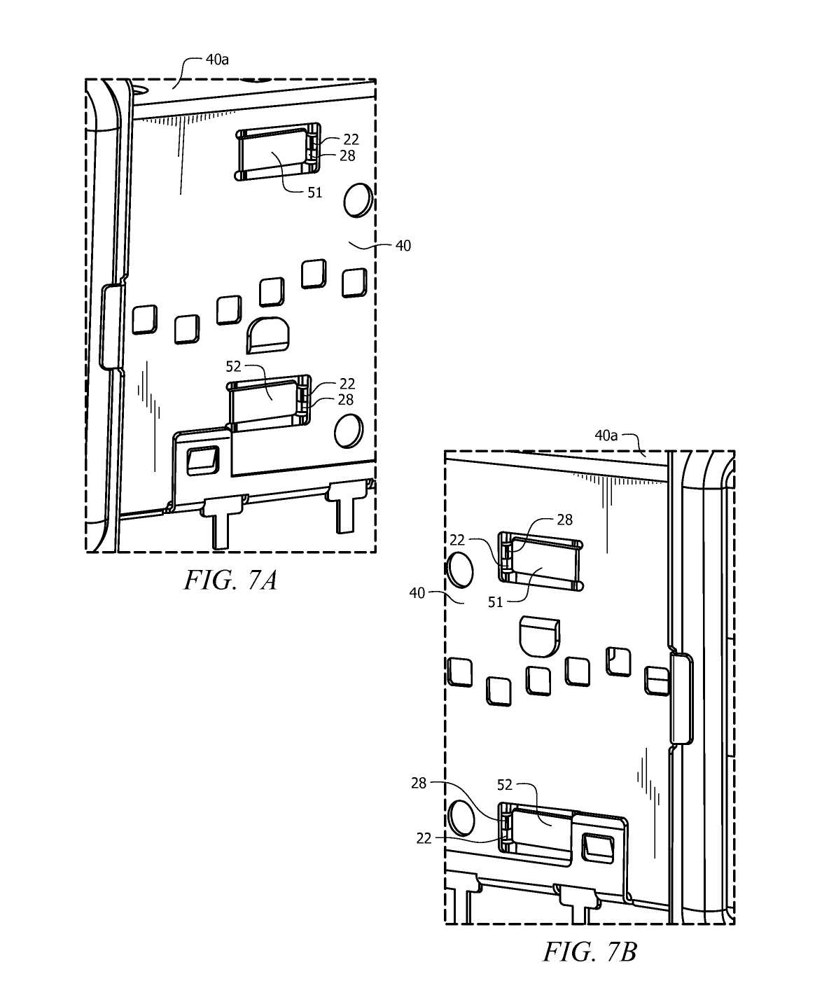

FIG. 1 illustrates a front perspective view of an optical transceiver module 1 equipped with an illustrative embodiment of the latching/delatching mechanism 10. FIG. 2 illustrates an enlarged view of the portion of the latching/delatching mechanism 10 shown in the dashed box labeled 11 in FIG. 1. FIG. 3 illustrates a front perspective view of a delatching device 20 of the latching/delatching mechanism 10 shown in FIG. 1. FIG. 4 illustrates an enlarged view of the portion of the delatching device 20 shown in the dashed box labeled 21 in FIG. 3. FIGS. 5A and 5B illustrate side perspective views of the optical transceiver module 1 shown in FIG. 1 with the delatching device 20 of the latching/delatching mechanism 10 in the stored state and in the pulled (i.e., actuated) state, respectively. FIG. 6 illustrates a side perspective view of two of the optical transceiver modules 1 shown in FIG. 1 in the stored states inside of respective cage openings of a cage 40. FIGS. 7A and 7B illustrate enlarged views of portions of the right and left sides of the cage 40 shown in FIG. 6.

With reference to FIG. 1, the optical transceiver module 1 has a module housing 2 that comprises an upper housing portion 2a and a lower housing portion 2b that are secured together. Inside of the module housing 2, optoelectronic, optical and electrical components are housed for performing the operations of the transceiver module. The lower housing portion 2b has four receptacles 3 formed therein for mating with respective optical connectors disposed on ends of respective optical fiber cables (not shown). The optical connectors may be, for example, LC connectors (not shown), which are well known in the art.

The optoelectronic components (not shown) typically include one or more light sources (e.g., laser diodes, light emitting diodes (LEDs), etc.) and/or one or more light detectors (e.g., photodiodes, P-I-N diodes, etc.). The electrical components (not shown) typically include driver circuitry for driving the light sources to convert electrical data signals into optical signals and receiver circuitry for receiving and decoding optical signals into electrical data signals. The electrical components may also include a controller chip for controlling the operations of the transceiver module 1. The electrical and optoelectronic components are typically mounted on a circuit board 4, such as a printed circuit board (PCB), for example. The circuit board 4 has electrical contacts 5 on a back end thereof that come into contact with electrical contacts disposed inside of a receptacle at the back of the cage 40 (FIG. 6) when the module 1 is plugged into the cage 40. For this reason, the optical transceiver module 1 is typically referred to as a pluggable optical transceiver module. In accordance with this illustrative embodiment, the optical transceiver module 1 is a quad small form factor pluggable (QSFP) optical transceiver module, although the invention is equally application to any type of optical transceiver module, including other types of SFP and non-SFP optical transceiver modules.

The latching/delatching mechanism 10 comprises the delatching device device 20 (FIG. 3) and stops 22 (FIGS. 1 and 2) formed in the lower housing portion 2b of the module housing 2. As best shown in FIG. 3, the delatching device 20 comprises a pull tab 23, a longitudinal reinforcement member 24 connected to the pull tab 23, a lateral member 25 connected to the longitudinal reinforcement member 24, first a second slider portions 26 and 27 connected on proximal ends to the lateral member 25, and first and second sets of outwardly-curved ramps 28 disposed on distal ends of the first and second slider portions 26 and 27, respectively.

The first and second slider portions 26 and 27 grip opposite sides of the module housing 2 when the delatching device 20 is installed on the module housing 2 as shown in FIG. 1. The lateral member 25 (FIG. 3) clips to a spring (not shown) of the lower housing portion 2b. As will be described below in more detail, when a force is exerted on the pull tab 23 in the direction indicated by arrow 31, the delatching device 20 moves a limited distance in the direction indicated by arrow 31, thereby causing the first and second slider portions 26 and 27 to slide a limited distance along the opposite sides of the module housing 2 in the direction indicated by arrow 31. The aforementioned spring of the lower housing portion 2b exerts a force in the opposite direction indicated by arrow 32 to limit movement of the delatching device 20 in the direction 31 and to urge the delatching device 20 in the direction 32. In FIG. 1, the delatching device 20 is shown in the unpulled, or stored state, i.e., the state that the delatching device 20 would be in if the module 1 were latched inside of a cage.

In FIG. 2, it can be seen that there are multiple stops 22 formed in the opposite sides of the lower housing portion 2b, although only the left side of the lower housing portion 2b is shown in FIG. 2. The right side of the lower housing portion 2b is a mirror image of the left side of the lower housing portion 2b. As best shown in FIG. 2, there are multiple outwardly-curved ramps 28. In the stored state shown in FIG. 2, the stops 22 and the outwardly-curved ramps 28 are interleaved. In the stored state, the one or more of the stops 22 in each side of the lower housing portion 2b are in abutment with the latches disposed on opposite sides of the cage 40, as will be described below with reference to FIGS. 6 and 7. This abutment between the cage latches and the stops 22 prevents the module 1 from moving in direction 31 (FIG. 1) when the delatching device 20 is in the unpulled state shown in FIGS. 1 and 2.

In accordance with embodiments described herein, there are N stops 22 and N+1 ramps 28, where n is a positive integer that is equal to or greater than 2. Thus, in the illustrative embodiment depicted in FIGS. 1 and 2, there are three stops 22 and four ramps 28. It can be seen that the ramps 28 interleave the stops 22 and that the ramps 28 and stops 22 are spatially distributed in a direction that is generally perpendicular to the direction 31 (FIG. 1) of retraction of the module 1 by the delatching device 20. This spatial distribution of the ramps 28 and interleaved stops 22 is particular well suited in cases where the cage latches are asymmetrically located on opposite sides of the cage, such as in the aforementioned side-by-side mounting configuration. The spatially-distributed stops 22 ensure that at least one of the stops 22 on each side of the module housing 2 is direct contact with the respective cage latch when the delatching device 20 is in the unpulled (non-actuated), or stored, state. The spatially-distributed ramps 28 ensure that at least one of the ramps 28 on the distal ends of the slider portions 26 and 27 will come into direct contact with the respective cage latch when the delatching device 20 is in the pulled state, or position.

It should be noted that while the spatially-distributed arrangement of stops 22 and ramps 28 is particularly well suited for arrangements in which the cage latches are asymmetrically located, the spatially-distributed arrangement of stops 22 and ramps 28 is equally well suited for arrangements in which the cage latches are symmetrically located. Because the slider portions 26 and 27 and their respective ramps 28 are symmetric, at least one of the ramps 28 will come into direct contact with the respective symmetrically-located cage latch when the delatching device 20 is in the pulled, or actuated, state or position. Because the stops 22 on opposite sides of the lower housing portion 2b are symmetric, at least one of the stops 22 on each side of the module housing 2 is direct contact with the respective symmetrically-located cage latch when the delatching device 20 is in the unpulled, or stored, state.

The module housing 2 is typically made of a die-cast metallic material, such as zinc, for example. The stops 22 are typically on the order of about 1.0 millimeters (mm) in width to ensure that they provide sufficient surface area for making contact with the cage latches to perform the latching operation. The longitudinal reinforcement member 24, the lateral member 25, the first a second slider portions 26 and 27, and the first and second sets of outwardly-curved ramps 28 are typically formed as a unitary piece of metallic material (e.g., sheet metal) that is been die cut or laser cut and bent into the shape shown in FIG. 3. The pull tab 23 is typically made of a hard plastic or rubber material. The width of the ramps 28 is typically also on the order of about 1.0 mm and is less than or equal to the spacing between adjacent stops 22. It should be noted, however, that the module housing 2 and the delatching device 20 are not limited to being made of any particular materials and are not limited to having any particular shapes or dimensions. Also, while the stops 22 are shown as being identical in shape and size and the ramps 28 are shown as being identical in shape and size, this is not a requirement.

In FIGS. 5A and 5B, the delatching device 20 is in the unpulled and pulled states, respectively. As described above, when the delatching device 20 is in the unpulled state, the delatching device 20 is urged in the direction of arrow 32 such that the stops 22 and the ramps 28 are interleaved as shown in FIG. 2. As also described above, when the delatching device 20 is in the pulled state, the delatching device 20 is moved in the direction of arrow 31 such that at least one of the ramps 28 of each of elongated portions 26 and 27 is in contact with the respective cage latch.

FIG. 6 shows two of the optical transceiver modules 1 shown in FIG. 1 latched inside of two cage openings of a cage 40. FIG. 7A illustrates an enlarged view of the portion of the right side of the assembly shown in FIG. 6 in dashed box 41. FIG. 7B illustrates a portion of the left side of the assembly shown in FIG. 6 opposite the portion shown in dashed box 41. As can be seen in FIGS. 7A and 7B, the cage 40 has two upper latches 51 located on opposite sides of the cage 40 and two lower latches 52 located on opposite sides of the cage 40. In accordance with this illustrative embodiment, the latches 51 are asymmetrically located on the cage 40, e.g., the distance of the latch 51 on the right side of the cage 40 from a top 40a of the cage 40 is less than a distance of the latch 51 on the left side of the cage 40 from the top 40a of the cage 40, as can be seen by comparing FIGS. 7A and 7B. Likewise, the latches 52 are asymmetrically located on the cage 40 such that the distance of the latch 52 on the right side of the cage 40 from the top 40a of the cage 40 is less than the distance of the latch 52 on the left side of the cage 40 from the top 40a of the cage 40, as can be seen by comparing FIGS. 7A and 7B.

In the stored positions of the optical transceiver modules depicted in FIGS. 6-7B, it can be seen that at least one of the stops 22 on the right and left sides of the cage 40 are in direct contact with the respective cage latches 51 and 52. It can also be seen that at least one of the ramps 28 on the right and left sides of the cage 40 is aligned with the respective cage latches 51 and 52 such that if the delatching device 20 (FIG. 3) is pulled, the ramps 28 will move under the respective latches 51 and 52 and press the latches 51 and 52 outwardly to disengage them from the respective stops 22. Thus, regardless of the asymmetric locations of the cage latches 51 relative to one another and of the cage latches 52 relative to one another, the latching and delatching operations are performed satisfactorily without encountering the aforementioned problems of the known designs.

The above description of the illustrative embodiments demonstrates that having multiple ramps 28 and multiple stops 22 that are interleaved, i.e., the ramps 28 and stops 22 are alternately positioned in the plane in which portions of the stops 22 and the ramps 28 both lie, provides redundancy that ensures that at least one of the stops 22 and at least one of the ramps 28 will directly encounter the respective cage latch 51, 52 on each side of the cage 40. It should be noted that while the illustrative embodiments depict an example where N=3, N can be any value equal to or greater than 2.

It should be noted that while the invention has been described with reference to an optical transceiver module, the invention is not limited to use with optical transceiver modules, but may also be used with optical receiver modules and optical transmitter modules. Therefore, the term “optical transceiver module,” as that term is used herein, describes any of the following: (1) a module that has both optical transmit and optical receive capability for transmitting and receiving optical signals over an optical waveguide; (2) a module that has optical transmit, but not optical receive, capability for transmitting optical signals over an optical waveguide; and (3) a module that has optical receive, but not optical transmit, capability for receiving optical signals over an optical waveguide.

It should be noted that the invention has been described with reference to a few illustrative embodiments for the purposes of demonstrating the principles and concepts of the invention. As indicated above, many modifications may be made to the embodiments described herein without deviating from the scope of the invention. For example, while the delatching device 20 is shown in the figures as having a particular configuration, it may have a variety of configurations that allow the goals of the invention to be achieved.

For example, some latching/delatching mechanisms use a bail instead of a pull tab in conjunction with slider portions to delatch the module from a cage. The principles and concepts of the invention apply equally to those types of actuator mechanisms that use bails for that purpose rather than pull tabs. Like the pull tab, the bail is an actuator mechanism that causes a force to be exerted on the slider portions to pull them in a direction away from the cage opening. In such arrangements, the bail is typically mechanically coupled to a lateral member and is rotational coupled to the module housing by pins. The lateral member, which is similar to the lateral member 25, is mechanically coupled to the slider portions such that rotating the bail in opposite directions causes the slider portions to move in opposite directions. A bail, a pull tab or any other suitable actuator mechanism can be used to perform this function.

Also, the outwardly-curved ramps 28 are only examples of possible delatching features disposed on the distal ends of the slider portions 26 and 27 that perform the function of pressing outwardly on the cage latches 51 and 52 to delatch them from the stops 22. Delatching features that have other shapes may also perform this function, as will be understood by those of skill in the art in view of the description being provided herein. In addition , while the latching/delatching mechanism 10 has been described for use with an optical transceiver module and a cage, mechanism 10, and modifications of it, are suitable for use with other types of modules for latching/delatching the modules to and from receptacles other than cages of the type described herein. Persons skilled in the art will understand, in view of the description provided herein, the manner in which these and other modifications may be made and that all such modifications are within the scope of the invention.

What is claimed is:

1. An optical transceiver module adapted to be mated with a cage, the module comprising:
a module housing having a top, a bottom, a first side, a second side, a first end and a second end, the first and second sides having first and second sets of stops formed therein, respectively, each of the first and second sets of stops having N stops, where N is a positive integer that is equal to or greater than 2; and
a delatching device mechanically coupled to a housing of the module, the delatching device comprising an actuator mechanism and first and second slider portions, the first and second slider portions having proximal ends that are mechanically coupled to the actuator mechanism and distal ends that are opposite the respective proximal ends, the first and second slider portions being positioned along the first and second sides of the module housing, respectively, the distal ends of the first and second slider portions having first and second sets of delatching features disposed thereon, the first and second sets of delatching features each having at least N+1 delatching features, wherein when the delatching device is in a non-actuated state, the stops of the first and second sets of stops are interleaved with the delatching features of the first and second sets of delatching features, respectively.

2. The optical transceiver module of claim 1, wherein the delatching device comprises a pull tab, a longitudinal reinforcement member connected to the pull tab, a lateral member connected to the longitudinal reinforcement member, wherein the proximal ends of the first and second slider portions are connected to opposite sides of the lateral member.

3. The optical transceiver module of claim 2, wherein the lateral member is movably coupled to the module housing in a manner that enables the lateral member to move to a limited extent in first and second directions, wherein the first direction is toward the first end of the module housing and away from the second end of the module housing and wherein the second direction is away the first end of the module housing and toward the second end of the module housing.

4. The optical transceiver module of claim 1, wherein if the optical transceiver module is installed in an opening of a cage and the delatching device is in the non-actuated state, at least one of the stops of each of the first and second sets of stops is in abutment with a respective latch of the cage, and wherein the abutment between the cage latches and the stops of the first and second sets of stops prevents the optical transceiver module from being removed from the cage opening.

5. The optical transceiver module of claim 4, wherein if the optical transceiver module is installed in an opening of a cage and the delatching device is in an actuated state, at least one of the delatching features of each of the first and second sets of delatching features presses against a respective latch of the cage to cause the abutment between the cage latches and the respective stops to be removed to allow the optical transceiver module to be removed from the cage opening.

6. The optical transceiver module of claim 1, wherein N is equal to or greater than 3.

7. The optical transceiver module of claim 6, wherein the delatching features are outwardly-curved ramps.

8. The optical transceiver module of claim 1, wherein the module is a small form-factor pluggable (SFP) optical transceiver module.

9. The optical transceiver module of claim 1, wherein the module is a quad small form-factor pluggable (QSFP) optical transceiver module.

10. An optical transceiver module assembly comprising:
a cage having a first end, a second end, a top, a bottom, a first side, and a second side, wherein an opening is formed in the first end, and wherein the first and second sides of the cage having first and second latches thereon, respectively, that extend a distance into the cage opening;
a module installed in the cage opening in a stored state, the module having a module housing having a top, a bottom, a first side, a second side, a first end and a second end, the first and second sides of the module housing having first and second sets of stops formed therein, respectively, each of the first and second sets of stops having N stops, where N is a positive integer that is equal to or greater than 2; and
a delatching device mechanically coupled to the module housing, the delatching device comprising an actuator mechanism and first and second slider portions, the first and second slider portions having proximal ends that are mechanically coupled to the actuator mechanism and distal ends that are opposite the respective proximal ends, the first and second slider portions being positioned along the first and second sides of the module housing, respectively, the distal ends of the first and second slider portions having first and second sets of N+1 delatching features disposed thereon.

11. The optical transceiver module assembly of claim 10, wherein when the module housing is installed in the cage opening in the stored state, the actuator mechanism is in a non-actuated state and at least one of the stops of each of the first and second sets of stops is in abutment with the first and second cage latches, respectively, and wherein the abutment between the cage latches and the stops of the first and second sets of stops prevents the optical transceiver module from being removed from the cage opening.

12. The optical transceiver module assembly of claim 11, wherein if the actuator mechanism is placed in an actuated state, at least one of the delatching features of each of the first and second sets of delatching features presses against the first and second cage latches, respectively, to cause the abutment between the cage latches and the respective stops to be removed to allow the optical transceiver module to be removed from the cage opening.

13. The optical transceiver module assembly of claim 11, wherein the delatching device comprises a pull tab, a longitudinal reinforcement member connected to the pull tab, a lateral member connected to the longitudinal reinforcement member, wherein the proximal ends of the first and second slider portions are connected to opposite sides of the lateral member.

14. The optical transceiver module assembly of claim 13, wherein the lateral member is movably coupled to the module housing in a manner that enables the lateral member to move to a limited extent in first and second directions, wherein the first direction is toward the first end of the module housing and away from the second end of the module housing and wherein the second direction is away the first end of the module housing and toward the second end of the module housing.

15. The optical transceiver module assembly of claim 14, wherein if the pull tab is pulled in a direction away from the cage substantially parallel to the first and second sides of the cage, the delatching device is placed in the actuated state to cause the abutment between the cage latches and the respective stops to be removed to allow the optical transceiver module to be removed from the cage opening.

16. The optical transceiver module assembly of claim 10, wherein the first and second cage latches are asymmetrically located relative to one another on the first and second sides of the cage, respectively.

17. The optical transceiver module assembly of claim 10, wherein N is equal to or greater than 3.

18. The optical transceiver module assembly of claim 10, wherein the delatching features are outwardly-curved ramps.

19. The optical transceiver module assembly of claim 10, wherein the module is a small form-factor pluggable (SFP) optical transceiver module.

20. The optical transceiver module assembly of claim 10, wherein the module is a quad small form-factor pluggable (QSFP) optical transceiver module.

21. An optical transceiver module adapted to be mated with a receptacle having first and second latches disposed on opposite sides thereof, the module comprising:
a delatching handle having a proximal end and a distal end;
a slider having first and second side slide members that are in parallel planes and a transverse member interconnecting proximal ends of the first and second side slide members, the transverse member being mechanically coupled to the distal end of the delatching handle, the first and second side slide members having distal ends that each have N+1 ramped features thereon, where N is a positive integer that is equal to or greater than 2, and wherein adjacent ramped features are separated from one another by respective spaces; and
a module housing mechanically coupled to the slider, the module housing having first and second catch features disposed on first and second sides of the module housing, respectively, for engaging the first and second latch features, respectively, disposed on opposite sides of the receptacle when the module is fully inserted into the receptacle and the delatching handle is in an unpulled, or non-actuated, state.

22. The optical transceiver module of claim 21, wherein if the delatching handle is placed in an actuated state, at least one of the ramped features of each of the first and second slide members presses against the first and second cage latches, respectively, to cause the first and second cage latches to disengage the first and second catch features, respectively, to allow the optical transceiver module to be removed from the cage opening.

23. The optical transceiver module assembly of claim 22, wherein the first and second catch features each comprise first and second sets of N stops, respectively, wherein adjacent stops of the N stops are spaced apart by a distance that is equal to or greater than a width of the ramped features, and wherein in the unpulled, or non-actuated, state, the stops of the first set of N stops are interleaved with the ramped features disposed on the distal end of the first slide member and the stops of the second set of N stops are interleaved with the ramped features disposed on the distal end of the second slide member.

24. The optical transceiver module of claim 23, wherein N is equal to or greater than 3.
